(19) United States
(12) Patent Application Publication
(10) Pub. No.: US 2020/0039064 A1
(43) Pub. Date: Feb. 6, 2020

(54) Low-Cost Compliant Robot Arm and System for Manipulation

(71) Applicant: The Regents of the University of California, Oakland, CA (US)

(72) Inventors: Stephen Alan McKinley, Berkeley, CA (US); David Gealy, Berkeley, CA (US); Pieter Abbeel, Piedmont, CA (US)

(73) Assignee: The Regents of the University of California, Oakland, CA (US)

(21) Appl. No.: 16/415,683

(22) Filed: May 17, 2019

Related U.S. Application Data
(60) Provisional application No. 62/715,348, filed on Aug. 7, 2018.
(60) Provisional application No. 62/715,248, filed on Aug. 6, 2018.

(51) Int. Cl. B25J 9/12; B25J 18/00; F16H 48/38

(52) U.S. Cl. CPC B25J 9/126; B25J 19/06; F16H 48/38; B25J 18/00

(57) ABSTRACT

A compliant robot includes a base and a compliant robot arm. The compliant robot arm includes a first quasi-direct drive assembly operatively connected to said base such that said compliant robot arm has at least one degree of freedom for motion relative to said base. The first quasi-direct drive assembly provides passive compliance such that said compliant robot arm has a back-drivable mode of operation for interactions between said compliant robot arm and an environment.

### CROSS-REFERENCE TO RELATED APPLICATION

This application claims priority to U.S. Provisional Application No. 62/715,248 filed Aug. 6, 2018 and U.S. Provisional Application No. 62/715,348 filed Aug. 7, 2018, the entire contents of both of which are hereby incorporated by reference.

### STATEMENT OF GOVERNMENT SUPPORT

This invention was made with government support under Grant Number 1351028 awarded by the National Science Foundation. The government has certain rights in the invention.

### BACKGROUND

### 1. Technical Field

The field of currently claimed embodiments of this invention relates to robotic arms and systems, and more particularly to low-cost, compliant robotic arms and systems for manipulation.

### 2. Discussion of Related Art

Current compliant robots are too expensive to be successfully commercialized outside of manufacturing plants and well-funded research labs, or suffer from problems such as low speed, poor force control, or reduced payload. Therefore, there remains a need for improved robotic arms and robotic systems.

### SUMMARY

According to some embodiments of the invention, a compliant robot includes a base and a compliant robot arm. The compliant robot arm includes a first quasi-direct drive assembly operatively connected to said base such that said compliant robot arm has at least one degree of freedom for motion relative to said base. The first quasi-direct drive assembly provides passive compliance such that said compliant robot arm has a back-drivable mode of operation for interactions between said compliant robot arm and an environment.

### BRIEF DESCRIPTION OF THE DRAWINGS

FIG. 1 shows a compliant robot according to an embodiment of the invention.

FIG. 2A is a schematic illustration of a first view of a compliant robot arm, wherein the direction of the pitch motion is indicated by the arrow P.

FIG. 2B is a schematic illustration of a compliant robot arm, wherein the direction of the roll motion is indicated by the arrow R.

FIG. 3 shows two pieces that together form a shell.

FIG. 4 shows an end effector having a quasi-direct drive assembly operatively connected to the end effector such that the end effector can open and close.

FIG. 5A is a schematic illustration of an exploded view of a link including a first quasi-direct drive assembly.

FIG. 5B is a schematic illustration of the link of FIG. 5A in an assembled state.

FIG. 6 is a schematic illustration of a geared differential in an exploded view and an assembled view.

FIG. 7 is a schematic illustration of first and second brushless motors in an exploded view and an assembled view.

FIG. 8 is a schematic illustration of the base in an exploded view and an assembled view.

FIG. 9 shows a link including a first quasi-direct drive assembly and a control processor.

FIG. 10 shows a motor mounted to a mounting plate.

FIG. 11 is a schematic illustration of a cutaway of the center plane of the compliant robot arm showing the release/insertion angle of the coupling teeth.

FIG. 12 shows a compliant robot including a first compliant robot arm and a second compliant robot arm.

FIG. 13 shows elbow bandwidth with varying payload. Position bandwidth of the elbow joint is compared to a similar test of the biceps brachii in humans [8]. Intersections between curves and the grey region represent frequencies beyond effective control (−3dB) for that loading condition. Raw data is shown as faded. Curves shown in solid were fit using a second order transfer function with a constant time delay.

FIG. 14 shows Table I, which lists physical properties of the compliant robot, referred to as “Blue.”

FIG. 15 is a schematic illustration of an internal view of a single 2-DoF geared differential module.

FIG. 16 shows a tensioner according to an embodiment of the invention. The improved embodiment of the design uses a clamping band tensioned with a lead screw to couple the links together.

FIG. 17 shows a person interacting with a compliant robot. The compliant robot arm is designed to minimize pinch points. Safety as a constraint during design heavily impacts the final form of a robot that will interact with human environments.

FIG. 18 shows a compliant robot teleoperating an espresso machine. A Virtual Reality operator (in background) pilots the robot using an HTC Vive system through a Unity bridge. A predictable 7-DoF ‘elbows out’ configuration is interpreted from 6-DoF Vive controller pose. Visual feedback is provided by an Intel RealSense D415 depth sensor.

FIG. 19 shows position-control repeatability measurement results. a) The arm was commanded to one of 8 End Poses (“x” targets) before returning to Home Pose (“+” target). Position is recorded after return-to-home. b) Home-pose repeatability is shown in the plane of highest variance. c) Torque hysteresis caused by friction encourages a bimodal distribution in return-to-home points dependent on direction. d) End-pose repeatability shown in the plane of highest variance for each set. Scale matches inset b, poses are arranged for clarity. Poses closer to the robot's torso tended to have higher variance.

FIG. 20 shows the actuator's response to an instantaneous change in position command. A 6 degree change in position (dashed line) was requested under three loading conditions. This overshoot correspond to 0.15, 1.1, and 2.3 degrees respectively.

FIG. 21 shows shoulder bandwidth with varying payload. Shoulder bandwidth with payload and arm fully extended is evaluated as a worst-case measure of the system's ability to respond to high frequency commands while loaded. Intersections between curves and the grey region represent frequencies beyond effective control (−3 dB) for each loading condition. Raw data is shown as faded, curves shown in solid were fit using a second order transfer function with a constant time delay.

FIG. 22 shows static torque bandwidth. A static torque response to a requested chirp signal was plotted to determine the maximum effective control bandwidth of the Blue system. The bandwidth was found to be 13.8 Hz which is greater than the bandwidth of human biceps muscle shown in a dashed line (2.3Hz [8]). Raw data is shown as faded, peaks are marked in circles, robot torque response is in solid blue. Intersections between curves and the grey region represent frequencies beyond effective control (−dB).

FIG. 23 shows power and energy of all actuators during pick and place. Inherent compliance and lower torque-density in the compliant robot's actuators means that it is most effective when moving like humans do. Humans rarely hold payloads at full extension, and humans usually manipulate objects close to the body. In FIG. 23, total power in all arm motors is tracked during a typical pick-and-place task. The robot can peak power output into the ‘thermal threshold’ for short durations as long as RMS Power is kept below 40 W.

FIG. 24 shows power and energy of individual motors during pick and place. Heat generation strongly informs arm behavior and design for thermal dissipation. Energy is shown here in solid colors, instantaneous power is shown faded). During a pick-and-place task 90% of total power is split between first three motors located in the Base (M1) and Shoulder (M2, M3). Power used in remaining arm motors (M4, M5, M6, and M7) are summed.

FIG. 25 shows Table II, which lists motor specifications and prototyping costs for compliant robot arms.

FIG. 26 shows Table III, a manufacturing Bill of Materials (BoM) cost breakdown for compliant robot arms.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

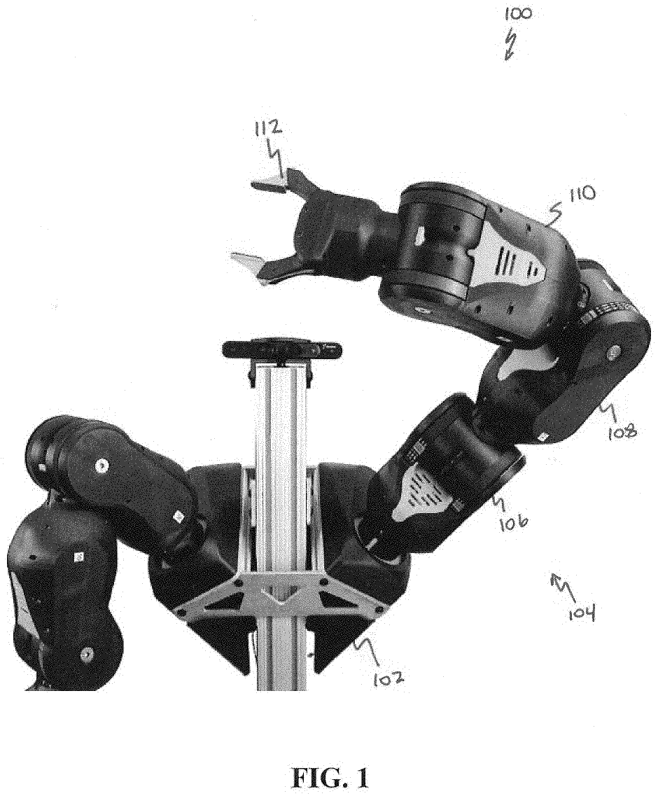

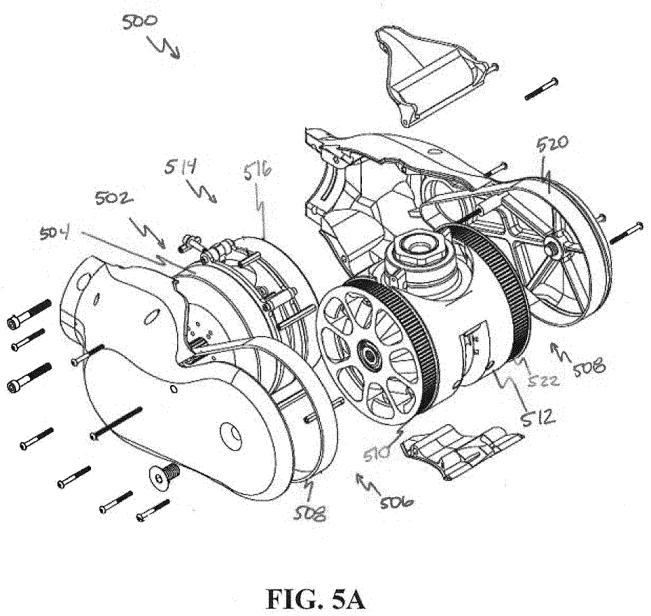

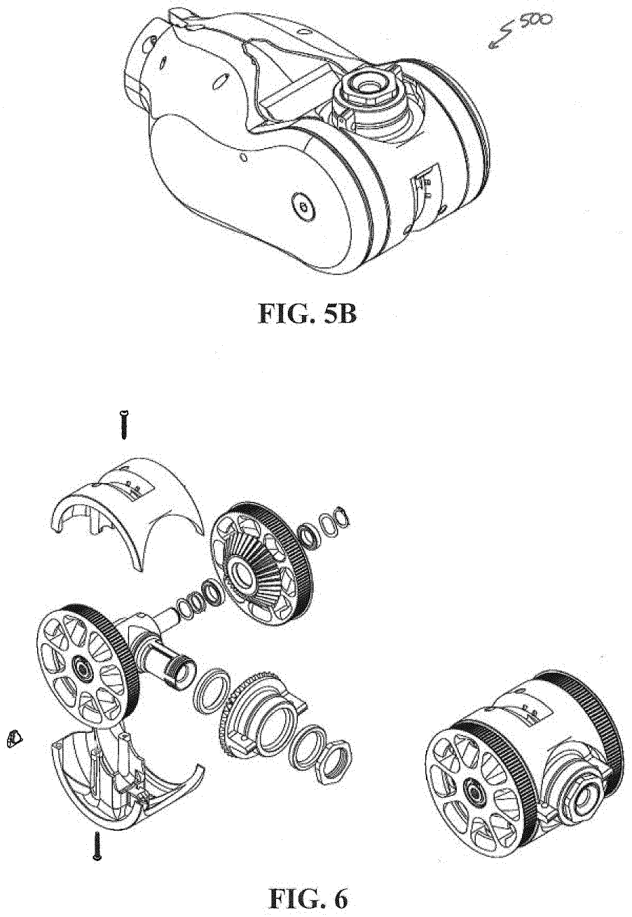

FIG. 1 is a schematic illustration of a compliant robot 100 according to an embodiment of the invention. The compliant robot 100 includes a base 102 and a compliant robot arm 104. The compliant robot arm 104 includes a first quasi-direct drive assembly operatively connected to the base 102 such that the compliant robot arm 104 has at least one degree of freedom for motion relative to the base 102. The first quasi-direct drive assembly provides passive compliance such that the compliant robot arm 104 has a back-drivable mode of operation for interactions between the compliant robot arm 104 and an environment. An example of the first quasi-direct drive assembly is shown in FIGS. 5A and 5B.

According to some embodiments of the invention, the compliant robot arm has a plurality of degrees of freedom, and each degree of freedom of the compliant robot arm is driven with a quasi-direct drive servo assembly. The quasi-direct drive servo assemblies have low gear ratios and motor inertias allow the arm as a whole (and each degree of freedom) to be passively compliant because they are backdrivable. A particular embodiment that is described herein has 7 degrees of freedom (plus an 8th degree of freedom in the hand).

The base 102 according to some embodiments of the invention is compliant in the same manner as each of the other degrees of freedom in the compliant robot arm 104. Although the description above describes the compliant robot as having the first quasi direct drive assembly, alternatively, the base can be considered to have the first quasi direct drive assembly. To create a 7-degree of freedom compliant robot arm, three similar links are coupled to the base, and a hand can optionally be added. The drive mechanism and transmissions of each of these degrees of freedom have similar properties in terms of back drivability, compliance, and transparency.

The following defines some terms used in the claims and the specification.

The term “actuator” means some combination of electric motor and transmission. If the transmission reduction ratio is 1:1, then the actuator would be considered “direct drive.”

“Backdriving” means applying a force to the output of an actuator, and transmitting that force through the transmission, causing the motor to move in response. The term “back-drivable” means that power is capable of flowing through a mechanism in the reverse direction, allowing external forces and/or torques to act on a motor without feedback control. A back-drivable actuator transmits force applied to the output of an actuator (through a transmission) to be felt by the motor. An example of a system with low backdrivability is a worm-gear tuning device on a guitar. The tuner will not rotate regardless of the tension in the string because of friction within the transmission. An example of a system with high backdrivability is a bicycle.

The term “quasi direct drive” means a low reduction transmission, typically less than 10:1. This is important because as gear reduction ratio gets larger (e.g. 100:1), friction within the gearbox becomes the dominating force during backdriving. An example of a system with high backdrivability is a bicycle; if you lift the bike off the ground and spin the rear wheel, the pedals will turn easily.

The term “transparency” means a property of backdrivable transmissions, wherein forces at the output of the transmission are felt by the motor, and forces at the motor very directly correspond to forces at the output of the transmission.

The term “passive compliance” means the ability for an actuator to move under external forces with no other feedback loops than motor current control. Passive compliance means that the robot, robot arm, etc. can comply with external forces and/or torques without the use of closed-loop feedback control. Passive compliance is important for the safety of humans and the environment surrounding the robot. However, stiffness is useful for manipulating objects in the world and performing useful tasks. Therefore, an ideal system for both would be passively compliant with the ability to act stiff: thereby creating a system that has ‘selectable impedance’.

The term “selectable impedance” means the ability for an actuator to select its output impedance. For example, an actuator could act like a spring-mass-damper system, reacting to external disturbances as a modeled spring-mass-damper system.

The term “environment” means objects in the compliant robot's operation space, with which the compliant robot may interact. The environment may include humans, animals, inanimate objects, and other robots, for example.

According to an embodiment of the invention, the compliant robot arm 104 includes a shoulder link 106 comprising the first quasi-direct drive assembly and a second quasi-direct drive assembly operatively connected to the base 102 such that the shoulder link 106 has least two degrees of freedom for motion relative to the base 102. The first and second quasi-direct drive assemblies provide passive compliance such that the compliant robot arm 104 has a back-drivable mode of operation for interactions between the compliant robot arm 104 and the environment.

According to an embodiment of the invention, the compliant robot arm 104 further comprises an upper arm link 108 including a third quasi-direct drive assembly and a fourth quasi-direct drive assembly operatively connected to the shoulder link 106 such that the upper arm link 108 has at least two degrees of freedom for motion relative to the shoulder link 106. The third and fourth quasi-direct drive assemblies provide passive compliance such that the compliant robot arm 104 has a back-drivable mode of operation for interactions between the compliant robot arm 104 and the environment.

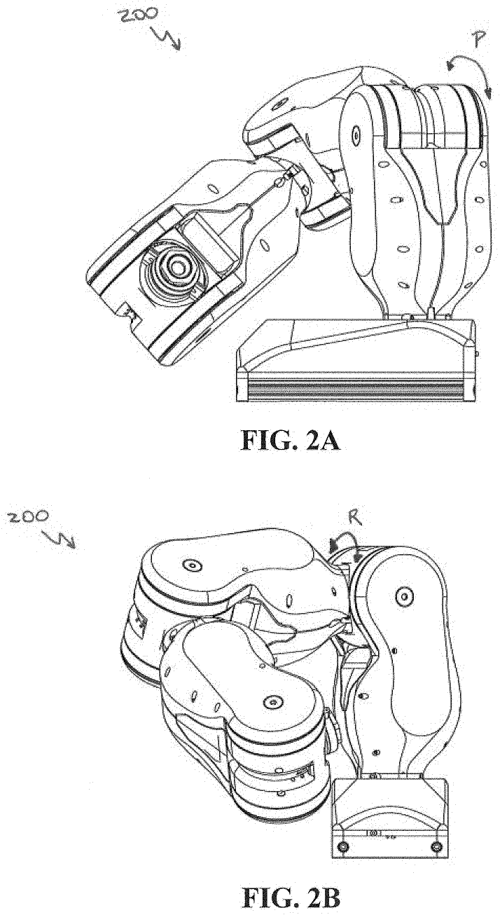

According to an embodiment of the invention, the first quasi-direct drive assembly and the second quasi-direct drive assembly enable a pitch motion of the upper arm link relative to the shoulder link. FIG. 2A is a schematic illustration of a first view of a compliant robot arm 200, wherein the direction of the pitch motion is indicated by the arrow P. According to an embodiment of the invention, the first and second quasi-direct drive assemblies further enable a roll motion of the upper arm link relative to the shoulder link. FIG. 2B is a schematic illustration of a compliant robot arm 200, wherein the direction of the roll motion is indicated by the arrow R.

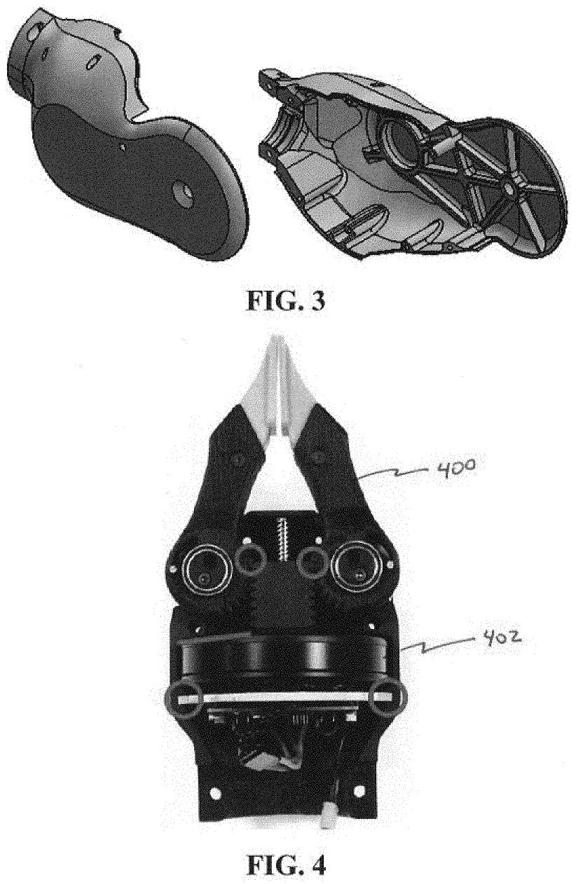

According to an embodiment of the invention, the shoulder link includes a first shell encasing the first and second quasi-direct drive assemblies, the upper arm link includes a second shell encasing the third and fourth quasi-direct drive assemblies, and the first shell has a same shape and size as the second shell. FIG. 3 shows an example of two pieces that together form a shell. The same size and shape of shell can be used for the shoulder link and the upper arm link. Further, the same size and shape shell can be used for all links and may contain different sized motors depending on the inertial loads on each link.

According to an embodiment of the invention, as shown in FIG. 1, the compliant robot arm 104 further includes a lower arm link 110 comprising a fifth quasi-direct drive assembly and a sixth quasi-direct drive assembly operatively connected to the upper arm link 108 such that the lower arm link 110 has at least two degrees of freedom for motion relative to the upper arm link 108. The fifth and sixth quasi-direct drive assemblies provide passive compliance such that the compliant robot arm 104 has a back-drivable mode of operation for interactions between the compliant robot arm 104 and the environment.

According to an embodiment, the third and fourth quasi-direct drive assemblies enable a pitch motion of the lower arm link 110 relative to the upper arm link 108. According to an embodiment, the third and fourth quasi-direct drive assemblies further enable a roll motion of the lower arm link 10 relative to the upper arm link 108.

According to an embodiment, the lower arm link 110 includes a third shell encasing the fifth and sixth quasi-direct drive assemblies, and the first shell has a same shape and size as the second shell and the third shell. An example of the first, second, or third shell is shown in FIG. 3.

According to an embodiment of the invention, as shown in FIG. 1, the compliant robot arm 104 further includes an end effector 112 and a seventh quasi-direct drive assembly operatively connected to the end effector 112 such that the end effector 112 has at least one degree of motion. FIG. 4 shows an example end effector 400 having a quasi-direct drive assembly 402 operatively connected to the end effector such that the end effector can open and close. The quasi-direct drive assembly 402 provides passive compliance such that the compliant robot arm has a back-drivable mode of operation for interactions between the compliant robot arm and the environment. According to an embodiment, the fifth and sixth quasi-direct drive assemblies enable a roll motion and a pitch motion of the end effector relative to the lower arm link.

According to an embodiment of the invention, the first quasi-direct drive assembly includes a brushless motor and a quasi-direct drive transmission. FIG. 5A is a schematic illustration of an exploded view of a link 500 including a first quasi-direct drive assembly 502. The first quasi-direct drive assembly 502 includes a brushless motor 504 and a quasi-direct drive transmission 506. The quasi-direct drive transmission 506 includes a timing belt 508 and a gear assembly 510. The gear assembly 510 connects the motor output to a geared differential 512. According to an embodiment, each quasi-direct drive assembly has a gear ratio that is less than 10:1.

As shown in FIG. 5A, each link may include a first quasi-direct drive assembly 502 and a second quasi-direct drive assembly 514. The second quasi-direct drive assembly 514 may include a brushless motor 516 and a quasi-direct drive transmission 518. The quasi-direct drive transmission 518 includes a timing belt 520 and a gear assembly 522. The gear assembly 522 connects the motor output to the geared differential 512. According to an embodiment, each of the first, second, third, fourth, fifth, sixth, and seventh quasi-direct drive assemblies has a gear ratio that is less than 10:1. According to an embodiment, the second, third, fourth, fifth, sixth and seventh quasi-direct drive assemblies each comprise a brushless motor and a quasi-direct drive transmission. FIG. 5B is a schematic illustration of the link 500 in an assembled state. The proximal end 524 may be connected to the base or to another link, while the distal end 526 may be connected to another link or to an end effector.

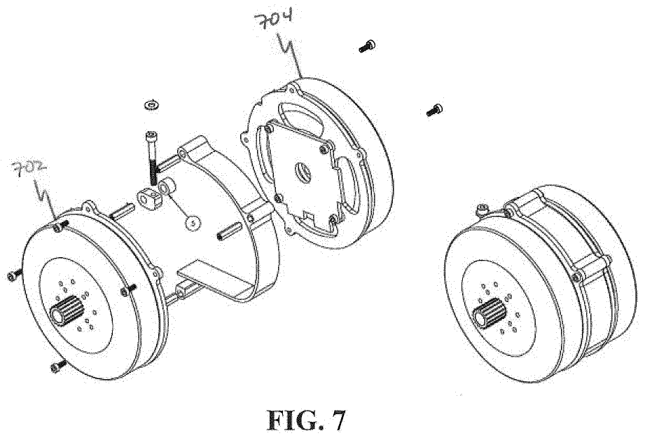

As described above, the shoulder link may include a geared differential coupled to the transmission. FIG. 6 is a schematic illustration of a geared differential in an exploded view and an assembled view. FIG. 7 is a schematic illustration of first and second brushless motors 702, 704 in an exploded view and an assembled view. As shown in FIGS. 5A and 5B, the geared differential 512 is positioned distal to the brushless motors 504, 516, i.e., farther from the base than the brushless motor of each of the first and second quasi-direct drive assemblies 502, 514. Shifting the motor mass proximally reduces gravity induced torques and flying inertia, as described in more detail below.

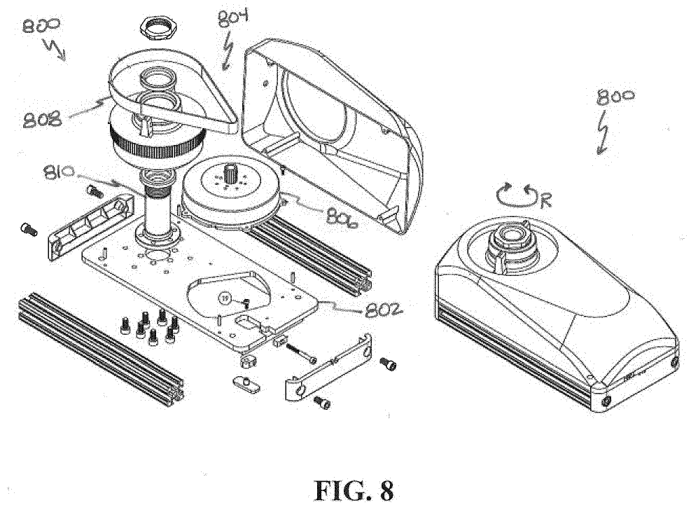

According to an embodiment of the invention, the base further includes an eighth quasi-direct drive assembly. FIG. 8 is a schematic illustration of the base 800 in an exploded view and an assembled view. The base 800 includes an aluminum plate 802, and an eighth quasi-direct drive assembly 804. According to an embodiment, the eighth quasi-direct drive assembly 804 includes a motor 806, a timing belt 808, and a geared output shaft 810 that couples to the shoulder link.

The eighth quasi-direct drive assembly 804 enables a roll motion of the shoulder link relative to the base. The direction of the roll motion is indicated by the arrow R. According to an embodiment of the invention, the eighth quasi-direct drive assembly 804 has a gear ratio that is less than 10:1, providing passive compliance such that the compliant robot arm has a back-drivable mode of operation for interactions between the compliant robot arm and an environment.

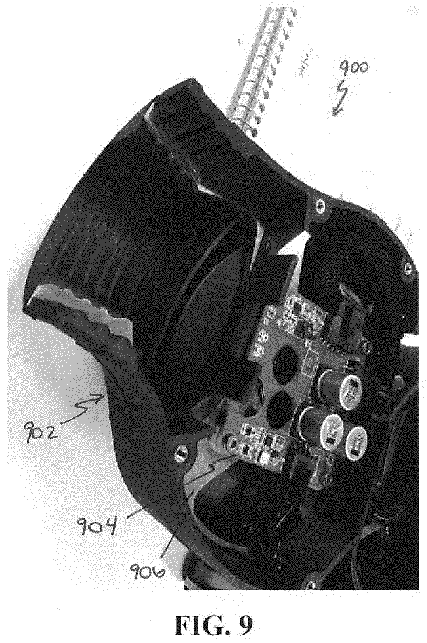

According to an embodiment of the invention, the compliant robot arm includes a control processor in communication with the first quasi-direct drive assembly, wherein the control processor controls the first quasi-direct drive assembly for the motion relative to the base. FIG. 9 shows a link 900 including a first quasi-direct drive assembly 902 and a control processor 904. The control processor 904 may include, for example, a driver board that is mounted on a motor mounting plate 906. The second first quasi-direct drive assembly and corresponding control processor and motor mounting plate are not shown. According to an embodiment, each quasi-direct drive assembly may be in communication with a corresponding control processor. The control processors may control the quasi-direct drive assemblies to actuate motion of the compliant robot arm. The control processors may be in communication with a central control processor. The central control processor may determine actuator torque commands and may send them to each servomotor through a shared bus. The central control processor may be a desktop computer or another microcontroller, for example.

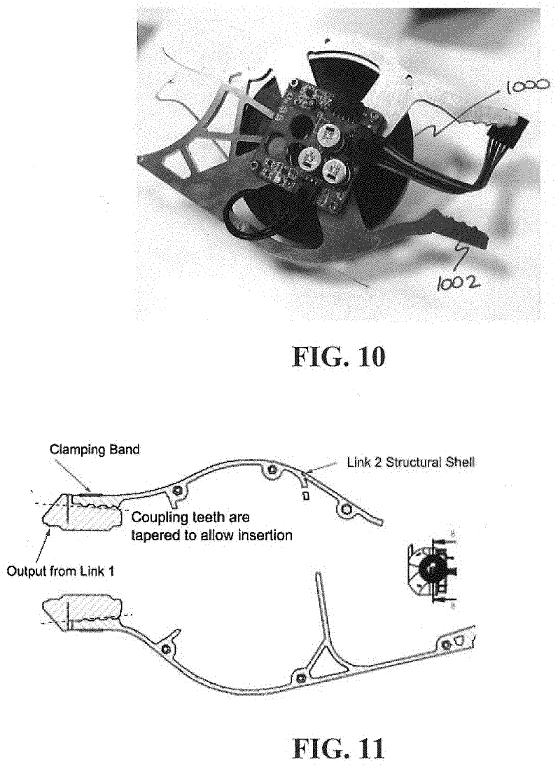

As shown in FIGS. 9 and 10, a motor mounting plate may be used to enhance the stiffness of the compliant robot arm. FIG. 10 shows a motor 1000 mounted to a mounting plate 1002. The motor and mounting plate may be placed back-to-back with a second motor and mounting plate in a link. The motor mounting plate 1002 couples directly to the previous stage's (link or base) output using a clamping band (not shown). As shown in FIG. 9, the motor mounting plate is coupled to the shell.

FIG. 11 is a schematic illustration of a cutaway of the center plane of the compliant robot arm showing the release/insertion angle of the coupling teeth. Also seen here is the clamping band around the joint. The coupling teeth couple to the output of the stage proximal to the link. The metal mounting plate also has coupling teeth, as shown in FIG. 10, which provide a rigid connection between the motor and the previous stage's output.

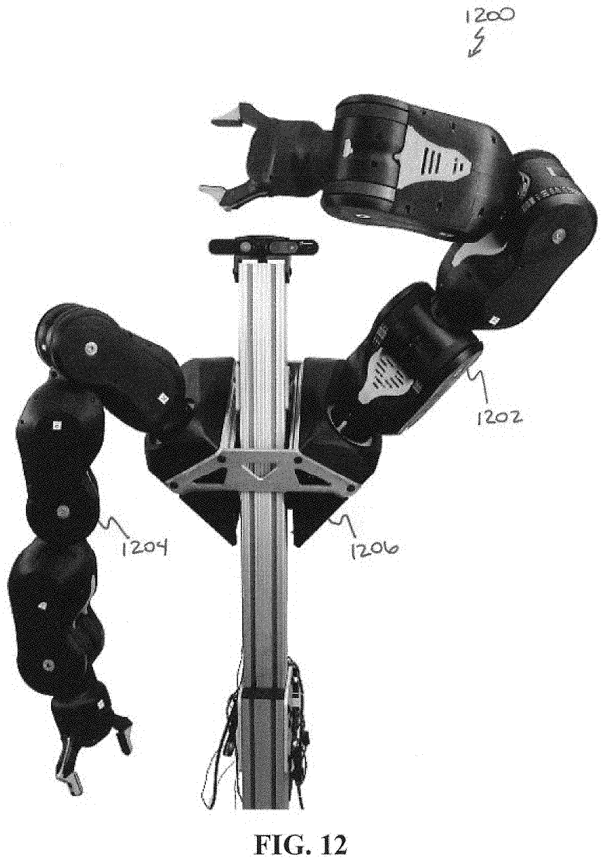

According to an embodiment of the invention, the compliant robot includes a second compliant robot arm. FIG. 12 shows a compliant robot 1200 including a first compliant robot arm 1202 and a second compliant robot arm 1204. The second compliant robot arm 1204 includes a ninth quasi-direct drive assembly operatively connected to the base 1206 such that the second compliant robot arm has at least one degree of freedom for motion relative to the base 1206. The ninth quasi-direct drive assembly provides passive compliance such that the second compliant robot arm 1204 has a back-drivable mode of operation for interactions between the second compliant robot arm 1204 and an environment.

An embodiment of the current invention is directed to a low-cost, easily commercializable, quasi-direct drive, compliant robot arm for manipulation in unconstrained environments. It is designed to be robust to impact and error in sensing. An example described in detail is a modular, torque controlled robot arm including a base link, three nearly identical arm links, and an end-effector. However, the general concepts of this invention are not limited to only this example. In particular, the compliant robot arm may include fewer or greater than three links.

Each degree of freedom is controlled by a servo unit that includes a brushless DC motor coupled to a driver board. Positional feedback is provided by a magnetic encoder on the board and a magnet mounted on the shaft of the motor pinion. The base link and the gripper each contain one servo and transmission. In the base, power is transmitted to an output through a timing belt reduction. In the gripper, a lead screw transmits power to the fingers. Each arm link contains two servo drives which transmit power to a geared differential (or cable differential, or friction differential) output through a timing belt reduction. Thus each arm link has ‘lift’ and ‘roll’ degrees of freedom, and the entire robot has 7 degrees of freedom (plus one in the gripper).

In each instance of the servo/transmission, the reduction is kept minimal (in one embodiment, the reduction is about 7:1) so that force applied to the robot from the environment can be transferred to the servo unit freely in both directions. This is quasi-direct drive which allows for high backdrivability, wherein the servo can react to external perturbations on the system without the need for additional sensors on the robot. This can keep the cost and complexity of the robot low.

Tension in the timing belts can be provided by either moving the servo assemblies away from the output (by tilting or sliding), or through the use of a moveable idler pulley. Support for the belt tension forces are resisted by an external plastic shell which also carry the loads created by the mass of the robot and the reaction with its environment. FIG. 16 shows a tensioner according to an embodiment of the invention. Two idler pulleys are used to tension the belts on each of the arm links. The pulleys are fixed together by an ‘h-plate’ that transfers load to the structural shell. The shell supports the pulleys with four screws that can be tightened to lock the tensioner in place. A fifth screw acts at the load adjuster for the tensioner mechanism (seen from the outside in the right-hand image in FIG. 16). This tensioning system enhances belt-wrap around the drive pinion of the motor, further eliminating the possibility of belt-skips.

The shell of each link is contoured so that fingers and objects are prevented from getting caught within the assembly. Each link is connected to the next by a coupler that resists torque and axial force through the addition of geometric features such as ridges. Bolts provide clamping force to hold each link in place.

Inertial Measurement Units (IMUS) containing accelerometers, gyroscopes, and/or magnetometers may be located on each driver board for tracking and calibration. These can also be used to detect collision with the robot's environment. Temperature sensors may be mounted on each board to monitor motor temperatures. A limit switch is used in the base to calibrate the first link. The configuration of the robot's Degrees of Freedom is designed to mimic those of a human (3 at the shoulder, 1 at the elbow, 3 at the wrist) so that the robot can be more predictably controlled through tele-operation (such as with a Virtual Reality system). Wiring and cables pass from one arm link to the next to transmit power, data, and control signals. In the lift axis of each arm link, these cables are collected in the free space within the link at full contraction and extend along the surface of a shroud during extension. This shroud prevents objects or people from getting caught in the differential mechanism of the robot arm. This shroud also acts as the hard-stop for full extension of the arm. Slip rings can be used to allow for continuous movement along the roll axis of each differential. Without slip rings, hard-stops can be used to limit rotation and preserve wiring such as for video or tactile data at the end-effector.

A low-cost compliant robot arm such as the one described here can be used for object manipulation in unconstrained environments. This is impactful for applications where collisions with the environment and/or people need to be allowed.

This piece of hardware was designed with the following general use cases in mind. All stated tasks can be teleoperated by humans in the short term, while allowing mass collection of data to enable learning from demonstrations and lead towards higher levels of automation.

The low-cost design enables humanoid robots to enter new spaces such as:
Home chores such as:
   cleaning
   decluttering
   laundry
   cooking
   unloading dishes
   food preparation
   getting the mail
Virtual Reality telepresence for use in:
   Physical telepresence for meetings
   Interacting with animals, such as spending time with a pet while on vacation.
   Elderly or disabled telepresence to manipulate their own environment
   Disaster response in hazardous environments
   Bomb disposal
   Remote warehousing and logistics
   Distributed micro warehouses
A kinematic, force-controlled interface for interacting with humans (such as in a virtual reality feedback mechanism, or a force controlled physical therapy device) with possible uses in:
   Haptic feedback for video games
   Companion robots

Arrayed groups of these robots can be used as ‘arm-farms’ for autonomously collecting data used in Reinforcement Learning.

This robot, according to an embodiment of the current invention, occupies a new space, capable of providing a human sized form factor with a useful payload. The development was motivated by current trends in Artificial Intelligence control methods which may use visual, tactile, or other methods for feedback besides exact robot position. AI-based controls methods are being used with ever-increasing efficacy in real-world scenarios. The next era of automation will involve robots that can recreate tasks, and skills, rather than simply repeating individual motions. Current advancements in two forms of robot-learning have been successful in achieving results: Learning from Demonstration (LfD) and Reinforcement Learning (RL).

LfD sometimes uses a human operator to provide correct demonstrations of a task for an algorithm to discover the salient details of a human's skill and decision process; and to figure out what information about its environment the algorithm may ignore (e.g. changes in background information). Demonstrations can be difficult to collect when a user must ‘puppet’ a complex robotic system. Demonstrations can be much more easily collected if a human-being can ‘be’ the robot, with their point-of-view projected from the robot's head, and the robot's end-effectors following the hands of the operator. Current examples of this method use sensor or visual feedback to consider environmental information important to the task-at-hand.

If the cost of the robot can be diminished, more data can be collected by having many robot systems working in parallel in similar (but not identical) environments. If the robots behave more like humans, and are designed to mimic human motions naturally, human operators can more easily provide useful demonstrations and can learn to ‘pilot’ the system more quickly. If the robots are inherently compliant, collisions between demonstrator-piloted robots and their environment are less damaging to both.

Reinforcement Learning (RL) is a method of machine learning that converges towards a goal state through the repeated execution of a method, measuring deviation from the goal, and attempting again with variation introduced to the executed policy. In this way, a robot can find successively more optimal solutions to achieve a goal. This goal, and initial guesses towards successful trajectories can be provided through demonstrations provided by a human pilot. LfD is one way to ensure a good starting point for RL methods to perfect. RL benefits from maximizing the number of robot-hours in executing and varying tasks. Again, if the cost of the robot can be diminished, more data can be collected and shared by many robots working in parallel. Having a compliant robot is important for RL, because introducing variation in policies can sometimes lead to the robot colliding with its environment.

The current hypothesis in machine learning research proposes that any task thusly demonstrated and reinforced may be learned, and reproduced, by a robot given enough data. Based on these observations, embodiments of the invention are designed to have a certain set of general characteristics, outlined as follows.

In order to have a meaningful impact within a human environment, the robot according to an embodiment of the current invention:
has 7 Degrees of Freedom plus an end-effector (arranged to mimic human kinematics)
can lift a 2 kg payload at ‘arms reach’ (payload capabilities increase closer to the base)
is inherently compliant (to allow for collisions)
is force-controlled (to allow for low-precision in the task-environment)
is robust (to allow for collisions)
is human-sized (to operate meaningfully in human environments)
has high control bandwidth (to eliminate the need for additional sensors)
is human safe
is low-cost (designed with a low number of simple components)

Advantages according to some embodiments of the current invention can include, but are not limited to:
Lower cost—this robot can be sold for less than $5,000 USD for consumers whereas the next competitor is around $30,000
Intrinsic force control—guaranteed force control stability in all environments
Scalable—does not rely on harmonic drives for torque amplification
Lower flying mass than other quasi-direct drive robots

In some embodiments, a single arm can be mounted to a table and used for a variety of automation tasks in human environments, ranging from developing new automation algorithms and robot learning techniques, to completing tasks in human environments such as loading, unloading, and folding laundry.

A two-armed system be achieved with two arms mounted around a (possibly articulated) spine that holds an articulated head. This embodiment can be used to capture full body kinematic demonstrations from a human pilot as shown in FIG. 18.

Arrayed groups of these robots can be used as ‘arm-farms’ for autonomously collecting data used in Reinforcement Learning.

### EXAMPLES

The following describes some concepts of the current invention with reference to particular embodiments. The general concepts of the current invention are not limited to the examples described.

The future of robotic manipulation is in unconstrained environments such as warehouses, homes, hospitals, and urban landscapes. Robots in these environments must operate with dexterity and safety alongside people despite imperfect actuation, lapses in sensing, and unmodeled contacts. Unlike traditional position-controlled manipulators, force-controlled robots can robustly react to unpredicted interactions without incurring damage to the environment or the robot itself. Existing compliant manipulators are too expensive or lack sufficient performance to complete useful tasks in human environments. Described herein is a fully realized paradigm for a low-cost Quasi-Direct Drive (QDD) manipulator.

Our design goals support recent trends in AI-based control methods. We believe these control methods can be more widely applied in human environments if force-controlled robots are made affordable.

A kinematically-anthropomorphic robot (7 Degrees of Freedom comprising 3 in the shoulder, 1 in the elbow, and 3 in the wrist) as shown in FIG. 1, can better mimic human motions, allowing better maneuverability in human environments, and enabling more intuitive teleoperation. This can be useful in Learning from Demonstration (LfD), where human operators provide demonstrations of tasks through methods including Virtual Reality (VR) teleoperation [1] [2].

If robot cost is reduced, iterative methods such as Reinforcement Learning (RL) which seek to maximize a given reward through the repeated refinement of a learned policy can be accelerated efficiently by allowing multiple systems to run policy refinement and iterate in parallel [3].

Requirements for high robot repeatability may be less important for both teleoperation and learning based methods that use visual feedback [4] [5]. Additionally, recent work utilizing domain randomization for AI-based policy generation suggests that lower-precision hardware can be used for grasping tasks [6]. Training for both LfD and RL often leads to collisions between the robot and environment [7]. Compliant robots can mitigate damage by controlling interaction forces.

These considerations shift the focus of designing hardware away from the constraints of highly structured manufacturing environments (which depend on robots with high repeatability and high bandwidth), and instead moves toward the broader question:

What hardware paradigms will most enable useful automation in unconstrained real-world human environments at low cost?

The following is described herein:
a design criteria for useful robotic manipulation in unconstrained environments,
an implementation of a robot arm that satisfies the above set of specifications,
evaluation of the physical characteristics of the design,
work towards DFM (design for manufacturing), and
production cost analysis.

We define a design paradigm that enables useful, low-cost robotic arms capable of manipulation tasks in unconstrained environments. We define useful in metrics similar to humans: humansize, 7 Degrees of Freedom, 2 kg payload, safe, compliant, and with a repeatability under 10 mm. We define low-cost as: pricing below $5000 to an end user for a manufacturing run of more than 1,500 arms. A partial set of tasks to consider includes: unloading a dishwasher, stocking a refrigerator, floor decluttering, opening doors, opening microwave ovens, sorting packages, physical stroke rehabilitation, folding laundry, cleaning windows, bed making, and bathroom cleaning. We demonstrate the robot in kitchen cleaning, table decluttering, telepresence, and machine tending.

Super-human bandwidth and payload capabilities enable high speed and high precision in constrained industrial automation tasks. However, if the goal is to safely manipulate household objects through human teleoperation while minimizing cost, performance trade-offs must be made. This motivates seeking new definitions for useful bandwidth and payload metrics for our design.

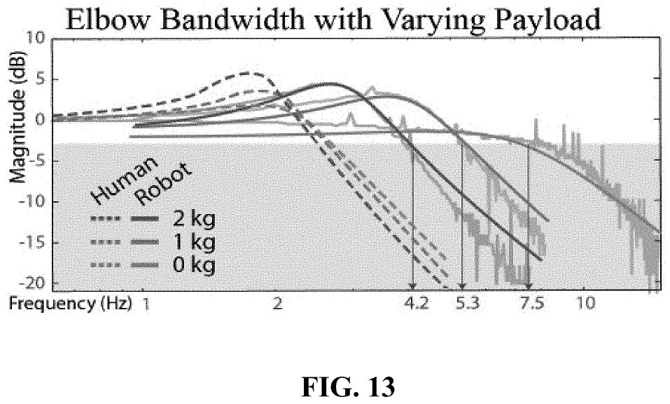

Bandwidth is a measure of an actuator's ability to deliver force (or control position) at higher frequencies. We believe a manipulator designed for human teleoperation can be perceived as useful if the robot's effective bandwidth is greater than that of the (human) user. As a lower bound for this design: studies on human muscle (biceps brachii) characteristics show that maximum effective position bandwidth is 2.3 Hz as found by Aaron et al [8]. See FIG. 13 for a comparison of human bandwidth characteristics and the compliant robot's properties.

Rated payloads for commercially available robots often cover conservative loading conditions: guaranteeing high bandwidth trajectory tracking in worst-case positions under continuous operation while holding a maximum ‘rated’ payload. We instead define a useful payload as one that can cover the largest set of outlined tasks, at human speeds. For example, position bandwidth can suffer under high payload, since dexterity at high payload is not universally required for the tasks considered.

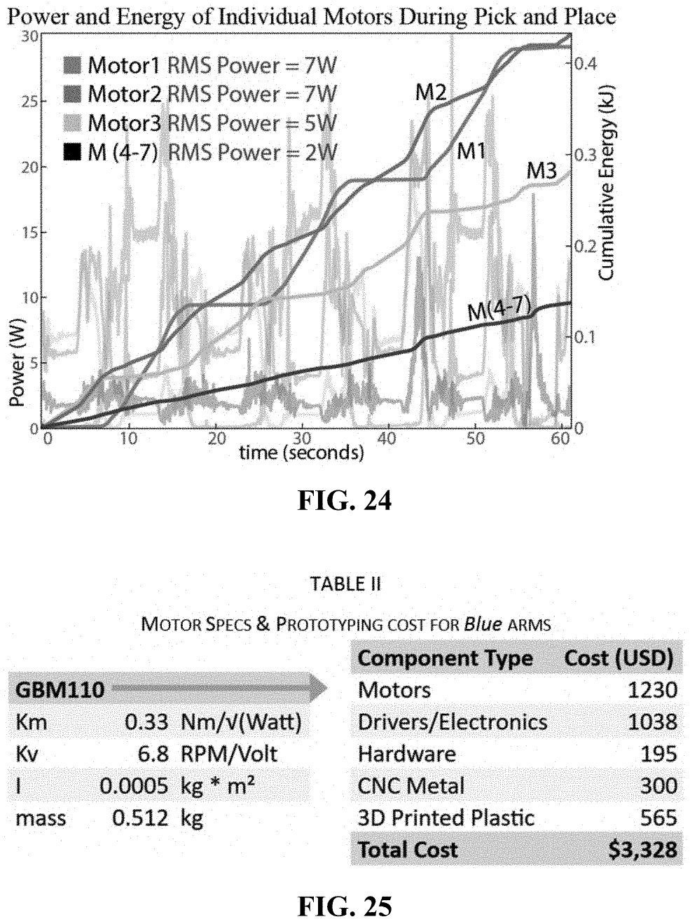

Drawing inspiration from nature, we consider how humans subconsciously minimize energy output during manipulation tasks [9]. Human arms have 1:1 arm mass to payload ratio (about 4 kg:4 kg), but humans cannot maintain full payload constantly (100% duty cycle). For object manipulation, humans have poor steady-state (RMS) force output, yet have high ‘burst power’ capability. Extending this to robot design, overall robot mass and inertia can be reduced if maximum loads are assumed as peaks of short-duration effort rather than requirements for continuous operation. Below and in FIGS. 23 and 24 we describe considerations for robots operating within a thermally limited paradigm.

A goal of this work is to lower the cost of general purpose robotic manipulators to be approximately equal in cost to a high performance research computer (<$5000).

Compliance is the ability for a robot to exhibit low impedance: moving when disturbed by an outside force. A rigid, non-compliant (high impedance) robot can be dangerous to operate near humans and destructive to itself or its environment during collisions. However, an entirely compliant robot will not be able to deftly manipulate objects nor respond to high frequency commands (low bandwidth).

Compliance can be passively inherent in systems or actively added to otherwise non-compliant systems. Active compliance can be achieved through sensing of output torques and feedback control and is found in series elastic actuation (SEA) [10] and modern cobots' [11]. Passive compliance is a characteristic of systems that can be driven by external forces with no use of feedback control.

Passive compliance can be achieved with backdrivable transmissions, wherein external forces applied at the output act on the motor and can be ‘sensed’ by measuring motor currents. Backdrivability enables highly robust torque control because the motor also acts as the torque sensor. Co-locating the sensor and actuator significantly eases dynamic stability problems present in force control [12].

High bandwidth actuation combined with inherently backdrivable transmissions allows a robot controller to select impedance (high or low) [13], helping match the unpredictable needs of real-world environments [14]. In the scope of our work, passive compliance is inherent within backdrivable actuation.

Kuka's LBR has excellent closedloop strain-based force control [15] and sells for upwards of $67,000. The similar Franka Emika arm is available for $29,900. Rethink Robotic's ‘Baxter’ was $25,000 (for two arms) and has been replaced by a single 7-DOF arm called ‘Sawyer’ available for $29,000. Currently all robots mentioned above except Baxter use harmonic drives that are not inherently compliant.

Most existing manipulators have high costs due to complex design approaches [16] [17]. Quigley's Low-Cost Manipulator is an example of robot design built for manipulation research which makes design trade-offs balancing elements such as cost, compliance, and payload [18]. Although Bill of Materials (BoM) part cost is estimated at ($4135), manufacturing costs and complexity were not accounted for. Other low-cost manipulators (with or without compliance) are currently achieved through reduced Degrees of Freedom [19] [20], and/or the use of off-the-shelf hobby servos and have significantly reduced payload [21].

Successful implementations of series elastic robots have shown that useful tasks can still be completed despite lower mechanical and control bandwidths [22]. However, it is not clear that existing SEA actuator solutions can be made low cost.

Backdrivable actuation holds promise for robots in unconstrained environments and enables selectable impedance with robust force control. Direct-drive is the most backdrivable, but high motor masses in the arm make high-DoF systems impractical. Instead, Quasi-Direct Drive (QDD) actuators (transmission ratios<10:1) can be used for legged locomotion and have the desirable properties of low friction, high backdrivability, toughness, simplicity, robust force control and selectable impedance. The primary drawback of this actuation method is reduced torque-density [13].

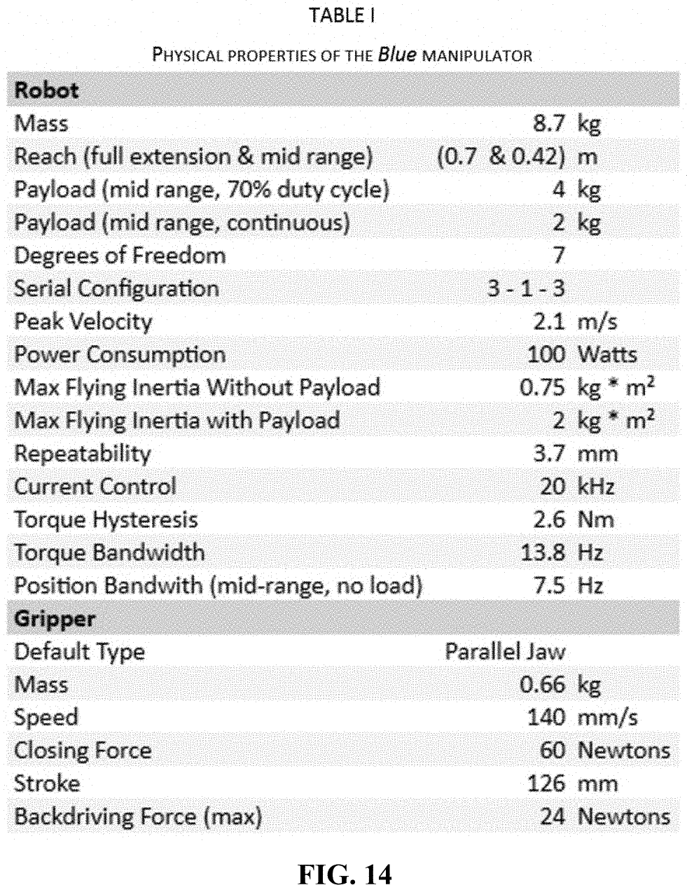

A full characterization of our design according to an embodiment of the invention is shown in Table I in FIG. 14.

QDD was chosen for the compliant robot because it can achieve backdrivability in a wide range of transmission options (gears, belts, cables, etc.), and has adequate torque density. Large gap-radius brushless outrunner gimbal motors from iFlight (see Table II in FIG. 25) were selected for their exceptional Km density at relatively low cost. Outrunners have higher torque density at the cost of reduced thermal dissipation and increased inertia [23]. Thermal considerations are discussed below.

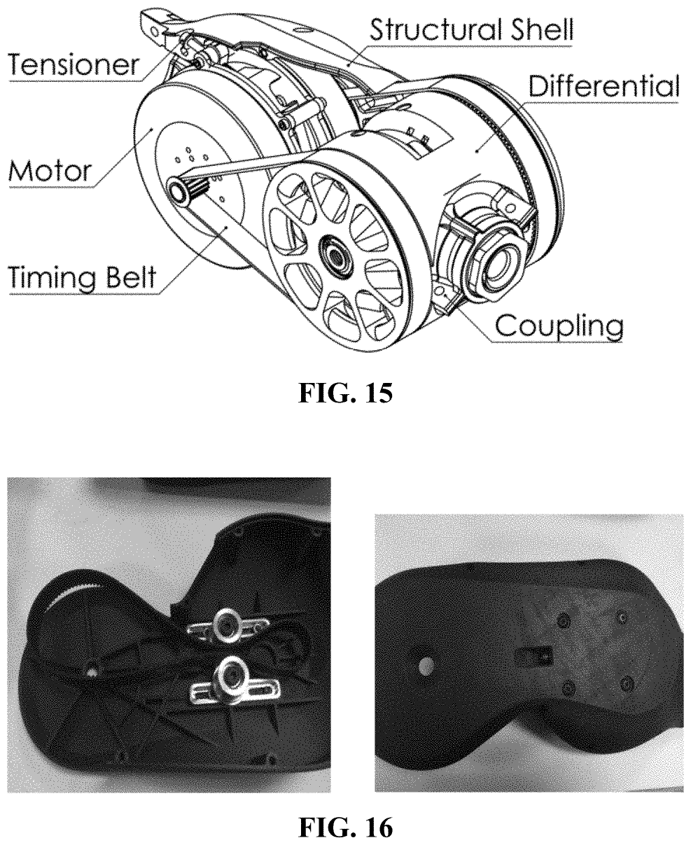

Timing belt transmissions were chosen over cables because of their relative ease of assembly and tensioning, durability, allowance for continuous rotation, efficiency (>95%), low backlash, and high backdrivability. 15 mm wide GT3 belts with fiberglass tension elements were chosen with 3 mm pitch to maximize the feasible single-stage gear ratio, transmitting power from a 16 tooth pinion to a 114 tooth output pulley resulting in a 7.125:1 single-stage reduction. Each link of the robot has a 2-DoF differential output, combining two planar QDD timing belt transmissions into output pitch and roll motions as seen in FIG. 15. Benefits of differential drive include partial load sharing when splitting induced gravitational loads.

An advantage of timing belts is their ability to transmit power over distance. Shifting the motor mass towards the shoulder reduces gravity induced torques and flying inertia, helping mitigate poor torque density inherent to QDD actuation. A conservative comparison is produced by locating a summed motor and transmission mass at each DoF, then calculating flying inertia and gravity induced torques about the shoulder. Shifting the motors back using timing belts results in an approximate 30% reduction in both gravity induced torque about the shoulder, and 30% reduction in flying inertia.

Geared differentials were chosen for their simplicity, reliability, impact resistance, continuous rotation, and lower part count. Because the differentials operate at low speed, large plastic teeth can be used under preloads with success.

The compliant robot according to an embodiment of the invention is a robot designed for potential interaction with humans. The modular, repeated structural shells are designed to house, protect, and support all components of the arm while concentrating design complexity into a few injectionmoldable parts that handle structure, safety from pinch points, and mechanical coupling between stages. The base of each shell is a two-bolt clamp that resists torque in all directions. The coupling between shells is limited in diameter to avoid potential finger-pinch points.

According to an embodiment of the invention, belt tension is applied by pivoting the servos assemblies away from the output pulleys using a lead screw. A single tension point balances loads on both timing belts. A drawback to this approach is that passive heat transfer from motor to environment is throttled to RMS 10 Watts per stage because the motors are isolated from thermal conductors. This limitation can be surmounted using a fan in the base. This drawback can also be surmounted by attaching the motors statically to a motor mounting plate and using movable tensioning idler pulleys to achieve belt tension (as is described in alternative embodiments herein).

A 1-DoF timing belt base was developed and coupled to a 2-DoF link to functionally create a 3DoF shoulder. While differential load sharing is removed, mounting the servomotor to a large aluminum base greatly increases both thermal mass and heat dissipation.

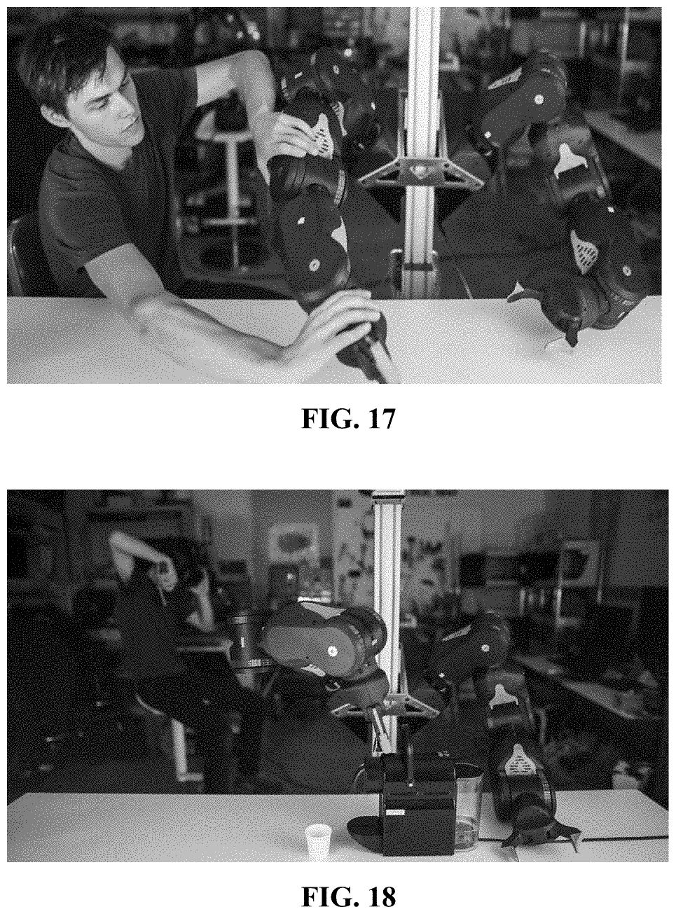

A low-cost parallel jaw gripper was designed and implemented as shown in FIG. 17. Comparable end-effectors used in research are often >$5,000 USD and would defeat the purpose of a low-cost paradigm. A servo module (same as in the rest of the arm) drives a backdrivable lead screw that actuates the four-bar-linkage fingers through a rack-and-pinion. Despite an increasing diversity of gripper paradigms, we chose parallel jaws for their predictability, robustness, simplicity (low cost), and ease of simulation [6].

The compliant robot's Quasi-Direct Drive actuation utilizes a single driver board per servo with all sensors co-located to minimize wiring complexity, connector failure points, and manufacturing cost. Custom motor drivers were developed for the compliant robot [24]. Each driver board is equipped with the following sensors: 14-bit absolute on-axis magnetic encoding for motor commutation and robot position sensing; 12-bit current sensing for closed-loop current (and thus torque) control of each servomotor; a 3-axis accelerometer for state estimation, collision detection and control as well as start-up robot calibration as envisioned in [25], and temperature sensors for thermal monitoring and shutdown if needed.

Power is supplied from a two-quadrant 48V 8A MeanWell switching regulator. Peak power can be anticipated at 250 W instantaneous, and 25 W continuous with no payload. A custom reverse current shunt circuit protects the low-cost power supply from reverse current-flow.

The compliant robot's control system is built around a central control computer (currently an Intel NUC, BOXNUC7I3BNK) that runs Ubuntu Linux and makes heavy use of the ros_control [26] framework. The computer determines actuator torque commands and sends them to each servomotor through a shared RS485 bus running at 170 Hz with a 1 Mbps data rate. Firmware updates, driver configuration, and motor calibration also leverage the same RS485 bus.

PID joint control is computed with feed-forward gravity and Coriolis compensation torques. Each servomotor locally runs real-time current control at 20 kHz.

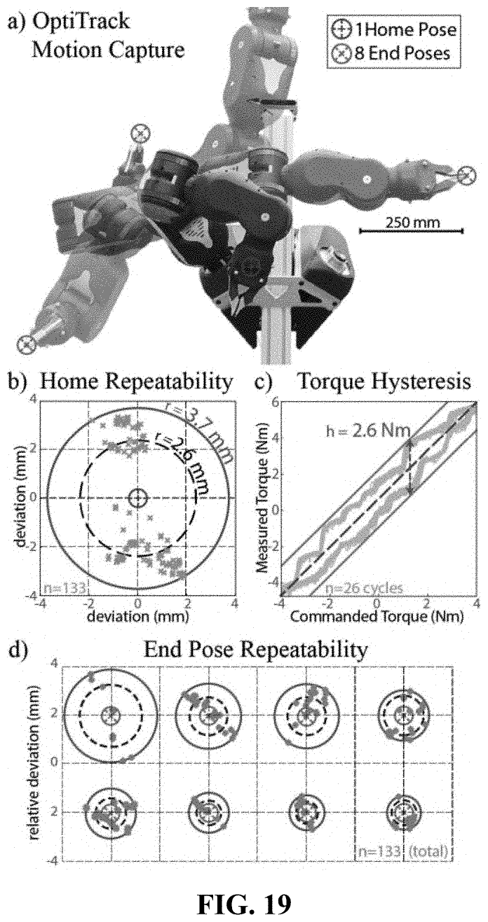

Controlling the 7-DoF end effector in real time through a 6-DoF VR teleoperation interface (as demonstrated in FIG. 19) requires a computationally efficient algorithm with joint state continuity. An iterative inverse kinematics solver is used with a secondary joint state objective to constrain the arm's redundant degree of freedom [27]. Teleoperation was made more intuitive by setting the secondary objective to match a human's resting position, with elbows naturally oriented. The joint error to this pose is optimized in the null space of the 7-DoF manipulator Jacobian. Other devices can be used to provide kinematic inputs to the robot including 6-DoF mice, joysticks, or human movement as captured by camera.

Telepresence allows the user to interact with others remotely and in real time. Operation of machinery (FIG. 18) is possible using the VR interface and the robot's compliance allows it to be safely manipulated in human environments.

Position-control repeatability was measured (similarly to [18]) by moving from a ‘home’ position to one of eight predefined dwell locations in the robot workspace (chosen in random order) and then back to home as shown in FIG. 19, panel a. Motion was recorded by an OptiTrack motion Capture system at 100 Hz. The standard deviation of the home pose was (0.89, 2.2, 1.6) mm for the (x, y, z) axis and (0.53, 0.29, 0.09) degrees for the (roll, pitch, yaw) axis. FIG. 19, panel b shows the distribution of home dwell points during 133 motions sliced across the plane of highest variance. All trials fell within a radius of 3.7 mm and the average deviation from the center of home poses was 2.6 mm. FIG. 19, panel d shows the distribution of end effector poses around each end point. Higher repeatability can be achieved through adding output joint encoders or visual feedback. Alternative embodiments of the coupling, motor mounts, and tensioners allow for greater structural stiffness of the robot and thereby increase its positional accuracy from the numbers provided here.

Friction (present in all actuators) limits backdrivability and degrades the potential for a motor to act as a torque sensor. This friction results in a torque hysteresis band, the height of which represents a bound on the uncertainty of the mapping between commanded torque and actual output torque. The static torque hysteresis band was measured by locking the actuator output, slowly cycling motor torque, and measuring output torque. The results of this show a worst case bound of 2.6 Nm for a full 2-DoF differential actuating an output roll as shown in FIG. 19, panel c.

Motor cogging torque accounts for 0.47 Nm of a total measured 0.89 Nm backdriving torque per single belt transmission. Torque ripple caused by motor cogging can be seen in 6.c. Although cogging torque is currently lumped with friction, methods exist to reduce this effect through additional calibration and feed-forward control [28]. Some of these methods can be implemented using the hardware as described in these embodiments, especially current feedback control which will reduce the perceived effects of friction and torque ripple.

A test cell was constructed to secure one 2-DOF modular link and measure output position in real time while incorporating stiffness of the belt transmission (1.3 kNm/rad), and lumping of differential, 3D-printed plastic shells, and 3Dprinted joint coupling stiffness (lumped at 1.2 kNm/radian). Masses were held vertically to avoid directional transmission pre-load from gravity and a rotary encoder was used to record arm translation via cable capstan transmission.

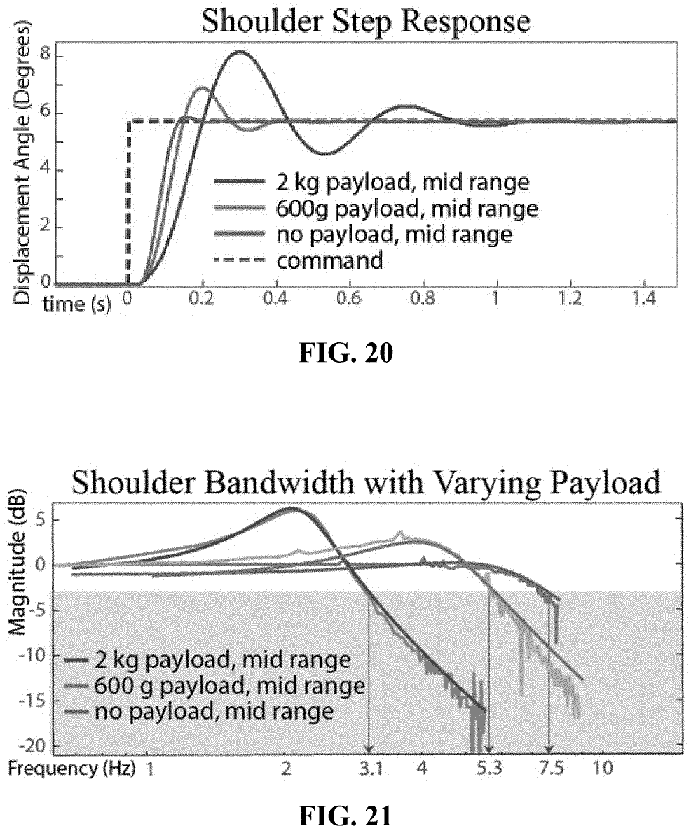

Step Responses: As seen in FIG. 20, step responses for the shoulder lift were performed with inertias of (0.13, 0.27, 0.76) kgm² representing (0, 0.6, 2) kg payloads at mid-range (50-70% robot reach). For a 6 degree step command, overshoot is (0.15, 1.1, 2.3) degrees, resulting in (0.1, 0.8, 2.8) cm of end-effector overshoot at mid-range. Underdamped dynamics can be partially handled through smoother trajectories, provided by either teleoperation or trajectory optimization.

Position Bandwidth: Position control bandwidth describes the maximum frequency with which an actuator can effectively track a pose command. FIG. 13 compares robot position bandwidth to that of humans' biceps brachii with varying payloads, while FIG. 21 describes position-control bandwidths for the shoulder for various mid-range loads.

Torque bandwidth is a measure of how quickly commanded torque can propagate through a transmission, resulting in a change in output torque. High torque bandwidth coupled with backdrivable transmission enables selectable impedance control, wherein the manipulator dynamics can be rapidly changed to best fit the interacting environment. Torque bandwidth was measured to better understand actuator performance in human environments.

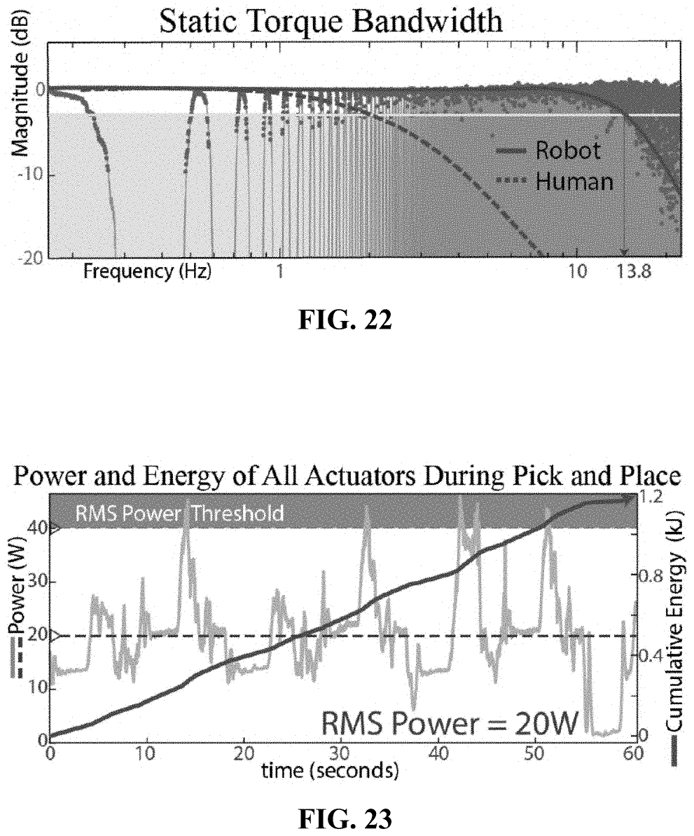

Torque bandwidth of a 2-DoF arm link was measured by grounding the actuator output to two 20 kg strain-based load cells whose signal is amplified by dual instrumentation amplifiers and then sampled by a 14 bit ADC with digital low-pass filtering, passing the data in real time at 400 Hz to a central computer. A 10 Nm chirp signal was commanded from 0.1 to 60 Hz over 300 seconds. As seen in FIG. 22, non-linear harmonics in the output frequency response caused output torque to occasionally peak at unity-gain. A conservative estimate of bandwidth torque follows the rolloff of the sampled peaks, resulting in an estimated control bandwidth of 13.8 Hz. The human performance limit in an anthropomorphically analogous setting is 2.3 Hz [8].

Maximizing backdrivability performance for QDD requires running motors near their thermal limits. Heat is generated (almost entirely) within the motors from I²R resistive losses. Achieving peak torque involves driving motors past their continuous thermal limits and motivates thermal testing. Average per-motor power consumption was evaluated then combined with measured thermal dissipation constants to inform peak capabilities of the robot.

Per-motor power was measured during a 60-second repetitive pick-and-place robot motion. Total RMS motor power is 20 Watts for ‘normal’ movement with no payload (seen in FIG. 23).

As shown in FIG. 24, 90% of power is split between the proximal three arm motors (Base-M1; and Shoulder-M2, M3). Shoulder motors (M2, and M3) dissipate comparable amounts of heat and can be treated conservatively as a lumped thermal model to plan peak (burst') arm capabilities in terms of % duty cycle. Integrated motor power is shown in solid colors, suggesting that simple average power models can be used for normal movement.

The base motor (M1) is bolted directly to a large aluminum base-plate which acts as a heat sink, providing significant thermal overhead. Within the body of the arm, thermal dissipation constants were measured at (0.93 W/° C. with a fan, and 0.3 W/° C. without a fan). With the fan engaged, shoulder motors can dissipate 40 W continuous at 70° C., resulting in a combined ≈20 Nm continuous output torque (0.5 kg payload fully outstretched), or 20 Watts of cooling overhead if the established average from FIG. 23 is respected.

Assuming a 20 Watt RMS ‘resting’ power, one can temporarily dump heat into the shoulder motors (estimated 1103 Ws/° K heat capacity), producing an excess of 35 Nm of torque for 23% of the time (duty cycle): capable of holding a 2kg payload at full extension with a 10 Nm dynamic overhead for upwards of 2 minutes before seeing a >10° C. rise in motor temperature, and having to ‘rest’ for 7 minutes. Shorter bursts are possible with less time spent resting, as long as total average power doesn't exceed 40 Watts.

A set of human tasks were attempted under teleoperation to evaluate the robot's qualitative performance, one of which is shown in FIG. 18. Challenges included gauging object depth through the constrained camera feed of the robot and commanding interaction forces, since a single controller tune was used and the only input is a 6-DOF position target in task-space. Successful tasks included operating an espresso machine, picking up m5 bolts, cleaning a table with paper towels, and decluttering.

We designed all plastic components to be injection molded for high volumes, metal pieces to be planar and simple to machine, and hardware to be commodity or sourced from existing high volume products such as bicycles, 3D printers, and drones. In the lab we fabricated seven compliant robot arms (of the version presented in this example) for testing. Arms can be deployed minimally as single units with base flat on table.

During a 7 unit fabrication run in-house, Bill of Materials (BoM) cost for each arm was tracked at $3328 as shown in Table II in FIG. 25. Plastics were printed on Markforged Onyx One and Monoprice MP Select Mini 3D printers. About 75% of our prototype costs were motors and driver boards. Machined components were sourced from a machine shops globally. Assembly took about 6 hours per robot arm. Assembly costs were not factored into Table II.

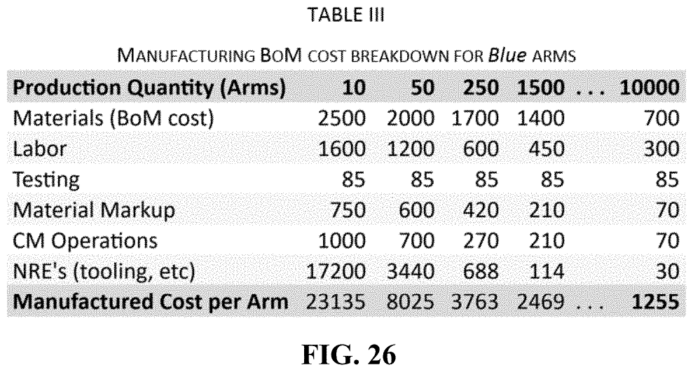

To fully evaluate a low-cost design paradigm for manipulation, we worked with three Contract Manufacturing (CM) companies to identify the costs of compliant robot arms produced at scale. We received quotes from three CM's in the California Bay Area from which we based the estimates presented in Table III in FIG. 26. Creating tooling for the 25 unique plastic components is estimated at $160,000. Other CM bring-up costs and Non Recoverable Engineering expenses (NRE's) could total $12,000. As shown in Table III, the end cost to consumers (assuming additional operational margins) can be kept within our $5,000 goal range if producing at volumes above 1,500 compliant robot arms.

### REFERENCES

[1] N. Koganti, A. Rahman H. A. G., Y. Iwasawa, K. Nakayama, and Y. Matsuo, “Virtual reality as a user-friendly interface for learning from demonstrations,” in Human Factors in Computing Systems, 2018, ser. CHI EA '18, 2018.

[2] T. Zhang, Z. McCarthy, O. Jow, D. Lee, K. Goldberg, and P. Abbeel, “Deep imitation learning for complex manipulation tasks from virtual reality teleoperation,” arXiv preprint ar Xiv: 1710.04615, 2017.

[3] S. Levine, P. Pastor, A. Krizhevsky, J. Ibarz, and D. Quillen, “Learning hand-eye coordination for robotic grasping with deep learning and large-scale data collection,” The International Journal of Robotics Research, vol. 37, no. 4-5, pp. 421-436, 2018.

[4] C. Finn, X. Y. Tan, Y. Duan, T. Darrell, S. Levine, and P. Abbeel, “Deep spatial autoencoders for visuomotor learning,” in International Conference Robotics and Automation. IEEE, 2016, pp. 512-519.

[5] Y. Duan, X. Chen, R. Houthooft, J. Schulman, and P. Abbeel, “Benchmarking deep reinforcement learning for continuous control,” in International Conference on Machine Learning, 2016, pp. 1329-1338.

[6] J. Mahler, J. Liang, S. Niyaz, M. Laskey, R. Doan, X. Liu, J. A. Ojea, and K. Goldberg, “Dex-net 2.0: Deep learning to plan robust grasps with synthetic point clouds and analytic grasp metrics,” arXiv preprint arXiv: 1703.09312, 2017.

[7] M. P. Deisenroth, C. E. Rasmussen, and D. Fox, “Learning to control a low-cost manipulator using data-efficient reinforcement learning,” in Robotic Systems and Science, vol. 7. MIT Press, 2011, pp. 57-64.

[8] S. Aaron and R. Stein, “Comparison of an emg-controlled prosthesis and the normal human biceps brachii muscle.” American journal of physical medicine, vol. 55, no. 1, pp. 1-14, 1976.

[9] Z. Mi, J. J. Yang, and K. Abdel-Malek, “Optimization-based posture prediction for human upper body,” Robotica, vol. 27, no. 4, pp. 607-620, 2009.

[10] G. A. Pratt, M. M. Williamson, P. Dillworth, J. Pratt, and A. Wright, “Stiffness isn't everything,” in experimental robotics IV. Springer, 1997, pp. 253-262.

[11] A. Albu-Schaffer, S. Haddadin, C. Ott, A. Stemmer, T. Wimbock, and G. Hirzinger, “The dlr lightweight robot: design and control concepts for robots in human environments,” Industrial Robot: an international journal, vol. 34, no. 5, pp. 376-385, 2007.

[12] S. D. Eppinger and W. P. Seering, “Three dynamic problems in robot force control,” IEEE Transactions on Robotics and Automation, vol. 8, no. 6, pp. 751-758, 1992.

[13] S. Seok, A. Wang, D. Otten, and S. Kim, “Actuator design for high force proprioceptive control in fast legged locomotion,” in Intelligent Robots and Systems (IROS), 2012 IEEE/RSJ International Conference on. IEEE, 2012, pp. 1970-1975.

[14] M. T. Mason, “Compliance and force control for computer controlled manipulators,” IEEE Transactions on Systems, Man, and Cybernetics, vol. 11, no. 6, pp. 418-432, 1981.

[15] R. Bischoff, J. Kurth, G. Schreiber, R. Koeppe, A. Albu-Schaffer, A. Beyer, O. Eiberger, S. Haddadin, A. Stemmer, G. Grunwald, et al., “The kuka-dlr lightweight robot arm-a new reference platform for robotics research and manufacturing,” in International symposium on Robotics. VDE, 2010, pp. 1-8.

[16] W. T. Townsend and J. K. Salisbury, “Mechanical design for wholearm manipulation,” in Robots and Biological Systems: Towards a New Bionics? Springer, 1993, pp. 153-164.

[17] K. A. Wyrobek, E. H. Berger, H. M. Van der Loos, and J. K. Salisbury, “Towards a personal robotics development platform: Rationale and design of an intrinsically safe personal robot,” in Robotics and Automation, 2008. ICRA 2008. IEEE International Conference on. IEEE, 2008, pp. 2165-2170.

[18] M. Quigley, A. Asbeck, and A. Ng, “A low-cost compliant 7-dof robotic manipulator,” in Robotics and Automation (ICRA), 2011 IEEE International Conference on. IEEE, 2011, pp. 6051-6058.

[19] T. Yamamoto, T. Nishino, H. Kajima, M. Ohta, and K. Ikeda, “Human support robot (hsr),” in ACM SIGGRAPH 2018 Emerging Technologies. ACM, 2018, p. 11.

[20] E. Eaton, C. Mucchiani, M. Mohan, D. L. Isele, J. M. Luna, and C. Clingerman, “C.: Design of a low-cost platform for autonomous mobile service robots,” in IJCAI Workshop on Autonomous Mobile Service Robots, 2016.

[21] “7bot: a $350 robotic arm that can see, think and learn!” Nov 2015. [Online]. Available: https://kck.st/1JcKvHG

[22] A. Edsinger-Gonzales and J. Weber, “Domo: a force sensing humanoid robot for manipulation research.” in Humanoids, vol. 1,2004.

[23] J. W. Sensinger, S. D. Clark, and J. F. Schorsch, “Exterior vs. interior rotors in robotic brushless motors,” in International Conference on Robotics and Automation. IEEE, 2011, pp. 2764-2770.

[24] A. Zhao, “Design of a brushless servomotor for a low-cost compliant robotic manipulator,” Master's thesis, EECS Department, University of California, Berkeley, May 2018.

[25] M. Quigley, R. Brewer, S. P. Soundararaj, V. Pradeep, Q. Le, and A. Y. Ng, “Low-cost accelerometers for robotic manipulator perception,” in Intelligent Robots and Systems (IROS), 2010 IEEE/RSJ International Conference on. IEEE, 2010, pp. 6168-6174.

[26] S. Chitta, E. Marder-Eppstein, W. Meeussen, V. Pradeep, A. R. Tsouroukdissian, J. Bohren, D. Coleman, B. Magyar, G. Raiola, M. Ludtke, et al., “ros_control: A generic and simple control framework for ros,” The Journal of Open Source Software, vol. 2, no. 20, pp. 456-456,2017.

[27] B. Siciliano and 0. Khatib, in Springer Handbook of Robotics. Berlin, Heidelberg: Springer-Verlag, 2007, pp. 247-251.

[28] M. Piccoli and M. Yim, “Anticogging: Torque ripple suppression, modeling, and parameter selection,” The International Journal of Robotics Research, vol. 35, no. 1-3, pp. 148-160,2016.

[29] D. W. Weir, J. E. Colgate, and M. A. Peshkin, “Measuring and increasing z-width with active electrical damping,” in Haptic interfaces for virtual environment and teleoperator systems, 2008. Haptics 2008. Symposium on. IEEE, 2008, pp. 169-175.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A compliant robot, comprising:
a base; and
a compliant robot arm comprising a first quasi-direct drive assembly operatively connected to said base such that said compliant robot arm has at least one degree of freedom for motion relative to said base,
wherein said first quasi-direct drive assembly provides passive compliance such that said compliant robot arm has a back-drivable mode of operation for interactions between said compliant robot arm and an environment.

2. The compliant robot of claim 1, wherein said compliant robot arm comprises:
a shoulder link comprising said first quasi-direct drive assembly and a second quasi-direct drive assembly operatively connected to said base such that said compliant robot arm has at least two degrees of freedom for motion relative to said base,
wherein said first and second quasi-direct drive assemblies provide passive compliance such that said compliant robot arm has a back-drivable mode of operation for interactions between said compliant robot arm and said environment.

3. The compliant robot of claim 2, wherein said compliant robot arm further comprises:
an upper arm link comprising a third quasi-direct drive assembly and a fourth quasi-direct drive assembly operatively connected to said shoulder link such that said upper arm link has at least two degrees of freedom for motion relative to said shoulder link,
wherein said third and fourth quasi-direct drive assemblies provide passive compliance such that said compliant robot arm has a back-drivable mode of operation for interactions between said compliant robot arm and said environment.

4. The compliant robot of claim 3, wherein said first quasi-direct drive assembly and said second quasi-direct drive assembly enable a pitch motion of said upper arm link relative to said shoulder link.

5. The compliant robot of claim 4, wherein said first quasi-direct drive assembly and said second quasi-direct drive assembly further enable a roll motion of said upper arm link relative to said shoulder link.

6. The compliant robot of claim 4, wherein said shoulder link includes a first shell encasing said first and second quasi-direct drive assemblies,
wherein said upper arm link includes a second shell encasing said third and fourth quasi-direct drive assemblies, and
wherein said first shell has a same shape and size as said second shell.

7. The compliant robot of claim 3, wherein said compliant robot arm further comprises:
a lower arm link comprising a fifth quasi-direct drive assembly and a sixth quasi-direct drive assembly operatively connected to said upper arm link such that said lower arm link has at least two degrees of freedom for motion relative to said upper arm link,
wherein said fifth and sixth quasi-direct drive assemblies provide passive compliance such that said compliant robot arm has a back-drivable mode of operation for interactions between said compliant robot arm and said environment.

8. The compliant robot of claim 7, wherein said third quasi-direct drive assembly and said fourth quasi-direct drive assembly enable a pitch motion of said lower arm link relative to said upper arm link.

9. The compliant robot of claim 8, wherein said third and fourth quasi-direct drive assemblies further enable a roll motion of said lower arm link relative to said upper arm link.

10. The compliant robot of claim 7, wherein said shoulder link includes a first shell encasing said first and second quasi-direct drive assemblies,
wherein said upper arm link includes a second shell encasing said third and fourth quasi-direct drive assemblies,
wherein said lower arm link includes a third shell encasing said fifth and sixth quasi-direct drive assemblies, and
wherein said first shell has a same shape and size as said second shell and said third shell.

11. The compliant robot of claim 7, wherein said compliant robot arm further comprises an end effector and a seventh quasi-direct drive assembly operatively connected to said end effector such that said end effector has at least one degree of motion, and
wherein said seventh quasi-direct drive assembly provides passive compliance such that said compliant robot arm has a back-drivable mode of operation for interactions between said compliant robot arm and said environment.

12. The compliant robot of claim 11, wherein said fifth and sixth quasi-direct drive assemblies enable a roll motion and a pitch motion of said end effector relative to said lower arm link.

13. The compliant robot of claim 1, wherein said first quasi-direct drive assembly comprises a brushless motor and a quasi-direct drive transmission.

14. The compliant robot of claim 1, wherein said first quasi-direct drive assembly has a gear ratio that is less than 10:1.

15. The compliant robot of claim 11, wherein each of said first, second, third, fourth, fifth, sixth, and seventh quasi-direct drive assemblies has a gear ratio that is less than 10:1.

16. The compliant robot of claim 11, wherein said second, third, fourth, fifth, sixth and seventh quasi-direct drive assemblies each comprise a brushless motor and a quasi-direct drive transmission.

17. The compliant robot of claim 16, wherein said shoulder link further includes a geared differential coupled to said quasi-direct drive transmission,
wherein said geared differential is positioned farther from said base than said brushless motor of each of said first and second quasi-direct drive assemblies.

18. The compliant robot of claim 11, wherein the base further comprises an eighth quasi-direct drive assembly, said eighth quasi-direct drive assembly enabling a roll motion of said shoulder link relative to said base.

19. The compliant robot of claim 18, wherein said eighth quasi-direct drive assembly has a gear ratio that is less than 10:1.

20. The compliant robot of claim 1, further comprising:
a control processor in communication with said first quasi-direct drive assembly, wherein said control processor controls said first quasi-direct drive assembly for said motion relative to said base.

21. The compliant robot of claim 1, further comprising:
a second compliant robot arm comprising a ninth quasi-direct drive assembly operatively connected to said base such that said second compliant robot arm has at least one degree of freedom for motion relative to said base,
wherein said ninth quasi-direct drive assembly provides passive compliance such that said second compliant robot arm has a back-drivable mode of operation for interactions between said second compliant robot arm and an environment.
